(19) United States
(12) Patent Application Publication
(10) Pub. No.: US 2004/0046507 A1
(43) Pub. Date: Mar. 11, 2004

(54) Lamp base comprising an eletronic component and a method for producing a lamp base

(76) Inventors: Andreas Alder, Oberhausen-Rheinhausen (DE); Matthias Burkhardt, M?uuml;nchen (DE); Ulrich Ringer, Ubstadt--Weiher (DE)

Correspondence Address: OSRAM SYLVANIA INC, 100 ENDICOTT STREET, DANVERS, MA, 01923, US

(21) Appl. No.: 10/381,414

(22) PCT Filed: Sep. 24, 2001
(86) PCT No.: PCT/DE01/03678

(30) Foreign Application Priority Data
Sep. 26, 2000 (DE) 100480012

(51) Int. Cl. H05B 37/02

(52) U.S. Cl. 315/71; 315/208; 315/297

(57) ABSTRACT

The invention relates to a lamp base comprising an electronic component with a mounting plate (20) and electronic SMD components (10) fixed thereon. The mounting plate (20) has bent sections (201-205), so that the surface (20a) intended for mounting the electronic components (10) has areas (201a-205a) located on different planes. The mounting plate (20) is preferably curved in a meandering fashion to allow a compact spatial placement of the electronic component (10).

The invention relates to a lamp base in accordance with the preamble of patent claim 1, and to a production method for such a lamp base.

### I. PRIOR ART

Patent specification U.S. Pat. No. 6,068,180 describes the making of contact with a semiconductor component on a mounting plate that has conductor tracks embedded in plastic. The contact surfaces of the conductor tracks are arranged at a different height in order to facilitate making contact with the terminals of the semiconductor component.

### II. SUMMARY OF THE INVENTION

It is the object of the invention to provide a lamp base comprising an electronic assembly arranged therein, the electronic assembly of which lamp base is optimally adapted to the prescribed shape and the prescribed inside dimensions of the base housing. It is also the object of the invention to specify a production method for a lamp base having an electronic assembly.

This object is achieved according to the invention by the features of patent claim 1 and of patent claim 4, respectively. Particularly advantageous designs of the invention are described in the subclaims.

The lamp base according to the invention has an electronic assembly with a mounting plate and electronic SMD components fastened thereon. The mounting plate has a surface provided for mounting the electronic components, and metal webs that are embedded in a dimensionally stable, electrically insulating material and that serve as conductor tracks and/or for making electrical contact with the electronic components on the mounting plate. According to the invention, the mounting plate has bent sections such that the surface provided for mounting the electronic components has regions arranged in different planes. As a result, the electronic assembly can be fitted into a housing of prescribed shape and with prescribed inside dimensions. In particular, the size and the shape of the bent sections of the mounting plate can be tuned to the spatial conditions of a housing into which the electronic assembly is to be inserted. The electronic SMD components fastened on the surface of the mounting plate of the electronic assembly thereby make optimum use of the available space, because they are arranged no longer substantially in a planar fashion, but in three dimensions. A particularly good utilization of space can be achieved with a meandering mounting plate. The bent sections of the mounting plate are advantageously connected via curved regions. This permits surface mounting of the electronic SMD components by means of a PCB assembly machine on the mounting plate, which is still flat. The final shape is not acquired by the mounting plate or the electronic assembly until a following fabrication step by bending the mounting plate in the region of the bending sites. In this way, the advantages of an automatic assembly of the mounting plate with electronic SMD components and of an optimum arrangement of the electronic components in the lamp base that is adapted to the spatial conditions are combined.

The method of production according to the invention for this lamp base comprises the following steps:

providing a flat metal sheet with prescribed desired bending sites about which the metal sheet can be bent,

producing a continuous metal frame from the metal sheet that has a surface for making contact with electronic SMD components, and which has metal webs that are provided as electrical conductors and/or ensure the unity of the metal frame,

form-fitting embedding of the metal frame in an electrically insulating material that can be adapted to the shape of the metal frame and can be brought into a dimensionally stable state such that the surface, provided for making contact with electronic components, of the metal frame remains accessible for the mounting of electronic components,

bringing the electrically insulating material into a dimensionally stable state such that the metal frame and the dimensionally stabilized electrically insulating material form a mounting plate,

if appropriate, severing of metal webs no longer required,

fastening and making contact with electronic SMD components on the mounting plate,

bending the mounting plate in the region of the desired bending sites such that the surface, serving for making contact with the electronic SMD components, of the metal frame has regions arranged in different planes, and

mounting the mounting plate (20) with the electronic SMD components (10) fastened thereon in the interior of a base housing.

As has already been explained above, the method of production according to the invention permits automated surface mounting of the electronic SMD components on the mounting plate by means of a PCB assembly machine and adaptation of the shape of the electronic assembly to the inside dimensions of a housing. The production of the metal frame is advantageously performed by punching the conductor track structure and the supporting webs from the metal sheet. Etching methods are not so well suited because of the comparatively large sheet thickness. Simple embedding of the metal frame in a dimensionally stable, electrically insulating material is advantageously achieved by injection-coating the metal frame with a plastic. The metal sheet advantageously has a reduced thickness in the region of the desired bending sites in order to facilitate bending of the mounting plate in this region.

The lamp base according to the invention can be, for example, a constituent of a high-pressure discharge lamp that can be used as headlight lamp in a motor vehicle. The electronic assembly advantageously includes electronic components that are interconnected as voltage transformer for generating the lamp operating voltage, as well as further electronic components that are a constituent of the ignition device required to ignite the gas discharge in the high-pressure discharge lamp.

### III. DESCRIPTION OF THE PREFERRED EXEMPLARY EMBODIMENT

The invention is explained in more detail below with the aid of a preferred exemplary embodiment. In the drawing:

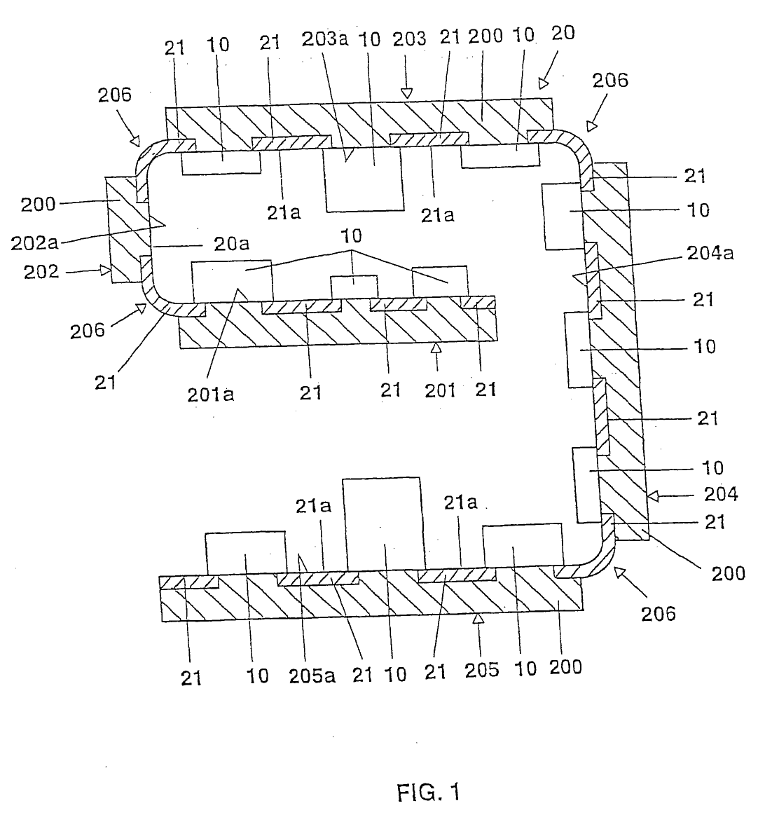

FIG. 1 shows a schematic cross section through the electronic assembly of a lamp base according to the invention, and

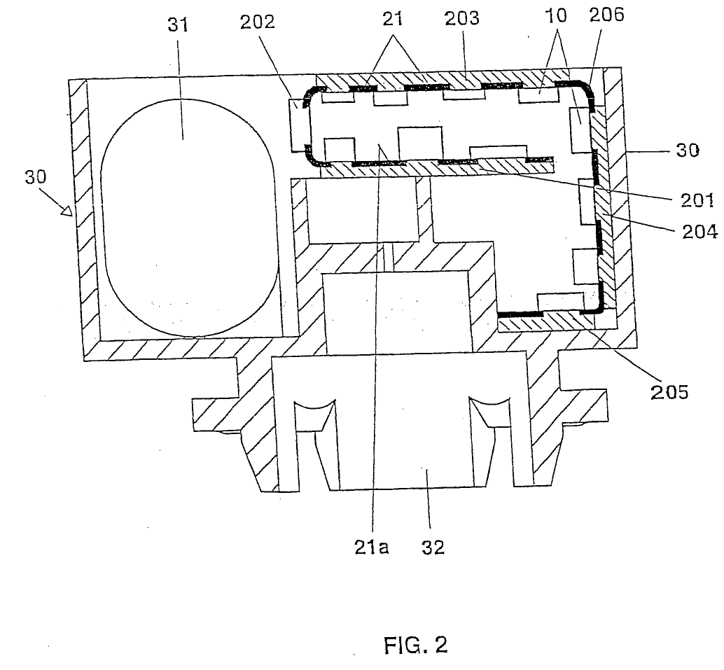

FIG. 2 shows a cross section through the base of a high-pressure discharge lamp with an electronic assembly arranged therein.

The electronic assembly depicted in FIG. 1 comprises a multiplicity of electronic components 10, in particular SMD (Surface-Mounted-Device) components that are fastened on a meandering mounting plate 20. The mounting plate 20 substantially comprises a dimensionally stable, electrically insulating plastic in which metal webs 21 are embedded. The metal webs 21 serve the purpose of mounting and making electrical contact with the electronic components 10 on the mounting plate 20. A few metal webs 21 additionally, or even exclusively, serve the purpose of preserving the unity and the mechanical stability of the mounting plate 20. The metal webs 21 are arranged in such a way that their surface 21a provided for making contact with the electronic components 10 is accessible. The contacting surface 21a of the metal webs 21 preferably terminate with the surface 20a of the mounting plate 20 that is provided for mounting the electronic components 10. In the case of the exemplary embodiment depicted in FIG. 1, the mounting plate 20 has five bent sections 201-205 that are connected via curved regions 206 of the mounting plate 20. The surface 20a is correspondingly divided up into five regions 201a-205a that are arranged in five different planes. A three-dimensional arrangement of the electronic components 10 is thereby achieved instead of a substantially planar one. In the preferred exemplary embodiment, the shape and the dimensions of the sections 201-205, as well as the placing of the curved regions 206 and the placing of the electronic components 10 on the mounting plate 20 are tuned to the inside dimensions of the base 30 of a motor vehicle high-pressure discharge lamp. The mounting plate 20 and the electronic components 10 mounted thereon are inserted as electronic assembly into the chamber, provided therefor, of the base 30 and are connected to the high-voltage transformer 31 arranged in a separate chamber and to the supply leads (not depicted) of the high-pressure discharge lamp (not depicted). Apart from the high-voltage transformer 31, the electronic assembly comprises all the electronic components of the ignition device, and the electronic components of a full-bridge inverter serving to operate the high-pressure discharge lamp.

A unipartite bronze sheet or brass sheet approximately 0.3 mm thick is used to produce the electronic assembly. The bronze or brass sheet can have a reduced thickness, for example by being notched, in the region of the desired bending sites 206. Stamped from this metal sheet in accordance with a prescribed mask is a continuous metal frame whose webs 21 form conductor tracks for the electronic components 10 mounted thereon, and/or serve to preserve the mechanical stability and the unity of the metal frame. Subsequently, the metal frame is injection-coated with a plastic, for example a polyamide. The webs 21 are embedded in a form-fitting fashion in the plastics material by the injection-coating of the metal frame with plastic. The injection-coating of the metal frame with plastic is performed, however, such that the surface 21a of the metal webs 21 that is provided for making contact with the electronic components 10 to be mounted remains accessible, that is to say remains uncovered by plastic. Likewise, neither are the desired bending sites 206 injection-coated with plastic. After the plastic has hardened and thus become dimensionally stable, the metal webs no longer required, which have served exclusively to preserve the mechanical stability and the unity of the metal frame, are removed. Their function is taken over by the now dimensionally stable plastic. The corresponding webs are therefore severed in a second stamping operation in order to avoid an electric short circuit between the electronic components 10 to be mounted. The dimensionally stable plastic and the metal webs 21 embedded therein form a mounting plate 20 with a substantially flat surface 20a that is provided for mounting electronic SMD components 10. The contacting surfaces 21a of the metal webs 21 terminate with the surface 20a of the mounting plate 20. A piece assembly machine is used to fix the electronic components 10, designed using SMD technology, on the surface 20a, and to solder them to the contacting surfaces 21a of the metal webs 21 serving as conductor tracks. A lead-free high-temperature solder is used for this purpose. Subsequently, the mounting plate 20 is bent in a meandering fashion in the region of the desired bending sites 206. The electronic component obtained in this way is inserted into the lamp base 30 and connected to the high-voltage transformer 31 and the electrical terminals of the base 30 as well as to the supply leads of the lamp (not depicted). A receptacle 32 for the high-pressure discharge lamp (not depicted) is provided in the base 30.

1. A lamp base comprising an electronic assembly arranged therein that has a mounting plate (20) with electronic SMD components (10) fastened thereon,
the mounting plate (20) having a surface (20a) provided for mounting the electronic SMD components (10), and
the mounting plate (20) having, embedded in a dimensionally stable, electrically insulating material (200), metal webs (21) that serve as conductor tracks and/or for making electric contact with the electronic SMD components (10) on the mounting plate (20),
characterized in that the mounting plate (20) has bent sections (201-205) such that the surface (20a) provided for mounting the electronic SMD components (10) has regions (201a-205a) arranged in different planes.

2. The lamp base as claimed in claim 1, characterized in that the bent sections (201-205) are connected to the mounting plate (20) via curved regions (206).

3. The lamp base as claimed in claim 1, characterized in that the mounting plate (20) is constructed in a meandering fashion.

4. A method for producing a lamp base that has a mounting plate (20) with electronic SMD components (10) fastened thereon, the method comprising the following steps:
providing a flat metal sheet with prescribed desired bending sites (206) about which the metal sheet can be bent,
producing a continuous metal frame from the metal sheet that has a surface (21a) for making contact with electronic SMD components (10), and which has metal webs (21) that are provided as electrical conductors and/or ensure the unity of the metal frame,
form-fitting embedding of the metal frame in an electrically insulating material (200) that can be adapted to the shape of the metal frame and can be brought into a dimensionally stable state such that the surface (21a), provided for making contact with electronic components (10), of the metal frame remains accessible for the mounting of electronic SMD components (10),
bringing the electrically insulating material (200) into a dimensionally stable state such that the metal frame and the dimensionally stabilized electrically insulating material (200) form a mounting plane (20),
if appropriate, severing of metal webs no longer required,
fastening and making contact with electronic components (10) on the mounting plate (20),
bending the mounting plate (20) in the region of the desired bending sites (206) such that the surface (20a), serving for mounting the electronic SMD components (10), of the mounting plate (20) has regions (201a-205a) arranged in different planes, and
mounting the mounting plate (20) with the electronic SMD components (10) fastened thereon in the interior of a base housing (30).

5. The method as claimed in claim 4, characterized in that the metal frame is produced by punching from the metal sheet.

6. The method as claimed in claim 4, characterized in that the form-fitting embedding of the metal frame in electrically insulating material (200) that can be adapted to the shape of the metal frame and can be brought into a dimensionally stable state is carried out by means of injection-coating the metal frame with a plastics material (200).

7. The method as claimed in claim 4, characterized in that the metal sheet has a reduced thickness at the desired bending sites (206).

8. The method as claimed in claim 4, characterized in that the desired bending site (206) is not covered with the electrically insulating material (200).
